(19) United States
(12) Patent Application Publication
(10) Pub. No.: US 2008/0280189 A1
(43) Pub. Date: Nov. 13, 2008

(54) Fabrication of Electrode Structures by Thermal Spraying

(75) Inventors: Olivera Kesler, Vancouver (CA); Nir Ben-Oved, Vancouver (CA)

Correspondence Address: OYEN, WIGGS, GREEN & MUTALA LLP;480 - THE STATION, 601 WEST CORDOVA STREET, VANCOUVER, BC, V6B 1G1, CA

(73) Assignee: THE UNIVERSITY OF BRITISH COLUMBIA, Vancouver, BC (CA)

(21) Appl. No.: 12/091,936

(22) PCT Filed: Oct. 27, 2006
(86) PCT No.: PCT/CA2006/001770

§ 371 Date: Apr. 28, 2008

Related U.S. Application Data
(60) Provisional application No. 60/730,380, filed on Oct. 27, 2005.

(51) Int. Cl. H01M 4/00; C23C 4/08

(52) U.S. Cl. 429/40; 427/455; 427/456

(57) ABSTRACT

A method for the rapid production of electrode structures such as Cu-SDC anodes for use in direct oxidation solid oxide fuel cells involves co-depositing a copper-containing material and a ceramic by plasma spraying to form a coating on a substrate. Layers of CuO-SDC have been co-deposited by air plasma spraying, followed by in-situ reduction of the CuO to Cu in the anodes. Materials having catalytic properties, such as cobalt, may also be incorporated in the structures. Controlled compositional or microstructural gradients may be applied to optimize the microstructure and composition of the coatings.

### REFERENCE TO RELATED APPLICATION

This application claims the benefit under 35 U.S.C. §119 of U.S. application No. 60/730,380 filed on 27 Oct. 2005, which is hereby incorporated herein by reference.

### TECHNICAL FIELD

This invention relates to the fields of electrochemical reactors and thermal spray deposition of materials. One embodiment of the invention provides methods for fabricating anodes suitable for use in solid oxide fuel cells.

### BACKGROUND

Fuel cells convert chemical energy of suitable fuels into electrical energy without combustion and with little or no emission of pollutants. Fuel cells may be made on a wide variety of scales. Fuel cells can be used to generate electrical power in any of a wide variety of applications including powering vehicles, auxiliary power units (APUs) and cogeneration of power and heat for residential and business uses.

Solid Oxide Fuel Cells (SOFCs) are solid-state fuel cells that typically operate at high temperatures. SOFCs can be highly efficient. One application of SOFCs is in stationary power generation, including both large-scale central power generation, and distributed generation in individual homes and businesses. High operation temperatures produce fast reaction kinetics and high ionic conductivity, and therefore high efficiency, but also create technological problems related to materials design and cell processing.

Hydrogen can be used as a fuel by solid oxide fuel cells. Using hydrogen as a fuel has the benefits of no local emissions, relatively low degradation rates and fast electrochemical kinetics. However, hydrogen must be generated, compressed, and transported, all of which require energy. Thus hydrogen fuel can be more expensive than other fuels.

SOFCs can be made to consume carbon-containing fuels, such as coal gas, methanol, natural gas, gasoline, diesel fuel, and bio-fuels and can use carbon monoxide as a fuel, in addition to hydrocarbons and hydrogen. Hydrocarbon fuels, such as methane, are typically converted through a process known as steam reforming to CO and H₂, which are then consumed electrochemically within the fuel cell. The reforming reaction can be performed outside of the fuel cell in a reformer. Reforming fuel outside of the fuel cell increases the overall cost and complexity of the system. In a high temperature SOFC system, fuel can be reformed within the fuel cell. A reforming catalyst, commonly nickel, may be provided in the SOFC, typically in the SOFC anode to assist the reforming reactions. This procedure is known as internal reforming. Internal reforming processes are described in J. Larminie, A. Dicks, Fuel Cell Systems Explained, Wiley, Chichester, 2000, pp. 190-197, for example.

Internal reforming eliminates the requirement for an external reformer and therefore simplifies the balance of plant system and reduces costs. In addition to reduced costs, internal reforming is endothermic for some fuels, such as methane, and can therefore assist in thermal management of the cell.

Internal reforming is limited in practice by technological issues. One issue is that internal reforming can result in carbon deposition on fuel cell anodes. Carbon deposition reduces the anode performance by blocking the reaction sites, and consequently, reduces the efficiency of the fuel cell. Also, some reforming processes require very high temperatures. For example, the equilibrium conversion of methane for a CH₄/H₂O ratio of one at 1 bar is only 37% at 600° C., 68% at 700° C., and 87% at 800° C. If reforming is to be performed internally in an SOFC, the high temperature requirement for equilibrium conversion limits the choice of materials that can be used to construct the fuel cell. 700° C. is at the working limit for many common metals. Another issue is that internal reforming processes can give rise to significant thermal gradients.

Direct oxidation of hydrocarbon (HC) fuels may alleviate some disadvantages of internal reforming. Fuel cells that directly oxidize hydrocarbons are described in R. J. Gorte, H. Kim, J. M. Vohs, Novel SOFC anodes for the direct electrochemical oxidation of hydrocarbon, Journal of Power Sources 106 (2002), 10-15. However, when HC fuel is directly utilized on conventional nickel-based fuel cell anodes, carbon deposited on the anode material due to a secondary cracking reaction blocks the reactants from reaching the reaction sites over time, and dramatically reduces the fuel cell performance and stability. Previous studies show that nickel can be utilized in direct oxidation of methane at temperatures between about 500° C. and 700° C. without significant carbon formation. It is unlikely that this could be achieved with higher hydrocarbons since the temperature window for pyrolysis will be lower and carbon formation more severe.

Some studies have suggested the use of copper as an alternative to nickel as the electronic conductor in SOFC anodes. Copper has high electrical conductivity and relatively low catalytic activity for hydrocarbon cracking. However, copper also has a low catalytic activity for hydrogen or hydrocarbon electrochemical oxidation. To improve cell performance, copper-containing fuel cell anodes have been made with ceria and samaria doped ceria in place of yttria stabilized zirconia (YSZ). Carbon deposition was not observed using this anode design. Ceria provides improved catalytic activity and mixed ionic-electronic conductivity, which increases reaction surface area in comparison to YSZ. However, these anodes are manufactured in a multi-step wet ceramic technique that is even more undesirably complicated and expensive than the multi-step techniques used to make nickel-YSZ anodes.

A variety of processing techniques have been suggested for the manufacturing of SOFC components. In high performance SOFCs, it is desirable to provide a thin electrolyte, typically on the order of about 5 mm to 10 mm thick. A thin electrolyte tends to reduce ohmic losses. In anode-supported planar SOFCs, the cathode layer is usually also fairly thin (20-40 mm), while a thicker anode (0.5-3 mm) is used as the mechanical support layer of the cell. Making an SOFC having thin electrode and electrolyte layers comprising ceramic materials having high melting temperatures typically requires a complex multi-step process.

SOFC processing typically includes a combination of wet powder compaction steps such as tape casting or extrusion, followed by deposition by a chemical or physical process such as spray pyrolysis, screen printing, or electrochemical vapor deposition, and then densification at elevated temperatures. The nature of the multi-step wet ceramic manufacturing procedures makes control over the electrode microstructure and material composition difficult. Processing of copper-based SOFC anodes is even more challenging, because copper oxides cannot be sintered together with the YSZ or ceria based electrolyte due to the large differences in melting temperatures between the copper and the ceramic material. R. J. Gorte, H. Kim, J. M. Vohs, Novel SOFC anodes for the direct electrochemical oxidation of hydrocarbon, Journal of Power Sources 106 (2002), 10-15 describe making copper-based SOFC anodes by impregnating a copper salt into a pre-sintered porous YSZ matrix. This method is also used for processing of Cu—Co based anodes.

The complex multi-step processing procedures are time consuming and involve significant capital costs, particularly when scaled up for mass production.

The inventors have recognized a need for cost-efficient methods for making electrodes, such as anodes for solid oxide fuel cells, and for improved electrode structures, particularly, improved structures for anodes for solid oxide fuel cells.

### SUMMARY

The following embodiments and aspects thereof are described and illustrated in conjunction with systems, tools, and methods which are meant to be exemplary and illustrative, not limiting in scope.

One aspect of the invention provides a method for making an electrodes. The method comprises thermal spraying onto a substrate a mixture comprising a copper-containing material and a second material having a melting temperature greater than a melting temperature of the copper-containing material to provide a coating on the substrate.

Another aspect of the invention provides methods for making electrodes. In some embodiments, the electrodes have application as anodes in solid oxide fuel cells. The method comprises providing a mixture comprising a first powder and a second powder and, thermal spraying the mixture onto a substrate. The first powder comprises a copper-containing material and the second powder is a powder comprising a second material having a melting temperature that is greater than a melting temperature of the copper-containing material.

Another aspect of the invention provides methods for forming porous copper-containing coatings on substrates. The methods comprise providing a mixture of a first powder comprising the copper in an oxidized state with a second powder comprising a ceramic material, plasma spraying the mixture onto a substrate and subsequently reducing the copper to metallic copper in situ.

Another aspect of the invention provides an anode for a fuel cell comprising a plurality of layers. The layers each comprise a mixture of a crystalline copper metal phase and a crystalline ceramic phase. The layers have differing compositions.

Further aspects of the invention and features of embodiments of the invention are set out below or will become apparent by reference to the drawings and by study of the following detailed descriptions.

### BRIEF DESCRIPTION OF DRAWINGS

Exemplary embodiments are illustrated in referenced figures of the drawings. It is intended that the embodiments and figures disclosed herein are to be considered illustrative rather than restrictive.

FIG. 1 is a flow chart illustrating a method according to an embodiment of the invention.

FIG. 2 is a schematic diagram illustrating apparatus that may be used in the practice of the method of FIG. 1.

FIG. 3 is an X-ray diffraction pattern for an SDC powder.

FIG. 4 is a plot showing a particle size distribution for the SDC powder.

FIGS. 5 and 6 are respectively optical and electron microscope images of the SDC powder.

FIG. 7 is a plot showing a particle size distribution for a CuO powder.

FIGS. 8 and 9 are respectively optical and electron microscope images of the CuO powder.

FIG. 10 is a scanning electron microscope image of a cross section of a plasma-sprayed CuO-SDC coating.

FIGS. 11 and 12 are respectively scanning electron microscope images of spray-dried SDC and CuO powders.

FIG. 13 is a plot showing deposition efficiency of CuO relative to SDC as a function of plasma gun power for specific plasma spraying conditions.

FIGS. 14 and 15 are X-ray diffraction patterns for plasma sprayed CuO-SDC coatings.

FIGS. 16 and 17 are scanning electron microscope images of plasma sprayed coatings.

FIG. 18 is a scanning electron microscope cross-sectional image of a plasma-sprayed SOFC anode coating.

FIG. 19 is an EDX map of the coating of FIG. 18.

FIGS. 20 and 21 show impedance spectra for the anode of FIG. 18 at various temperatures.

FIG. 22 is a plot of activation energy as a function of temperature for the anode of FIG. 18.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

One aspect of this invention provides methods for making electrode structures which involve thermal spray deposition of a copper-containing material together with a ceramic material. The thermal spray deposition may comprise plasma spraying. Plasma spraying has the advantage of short processing time, material composition flexibility, and a wide range of controllable spraying parameters that can be used to adjust the properties of deposited coatings. Spraying and feedstock parameters may be controlled during spraying to optimize the characteristics of the deposited materials.

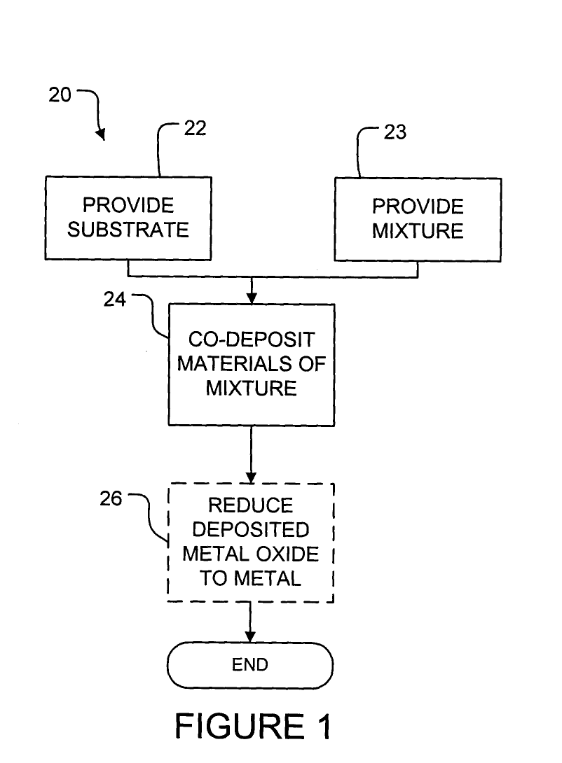

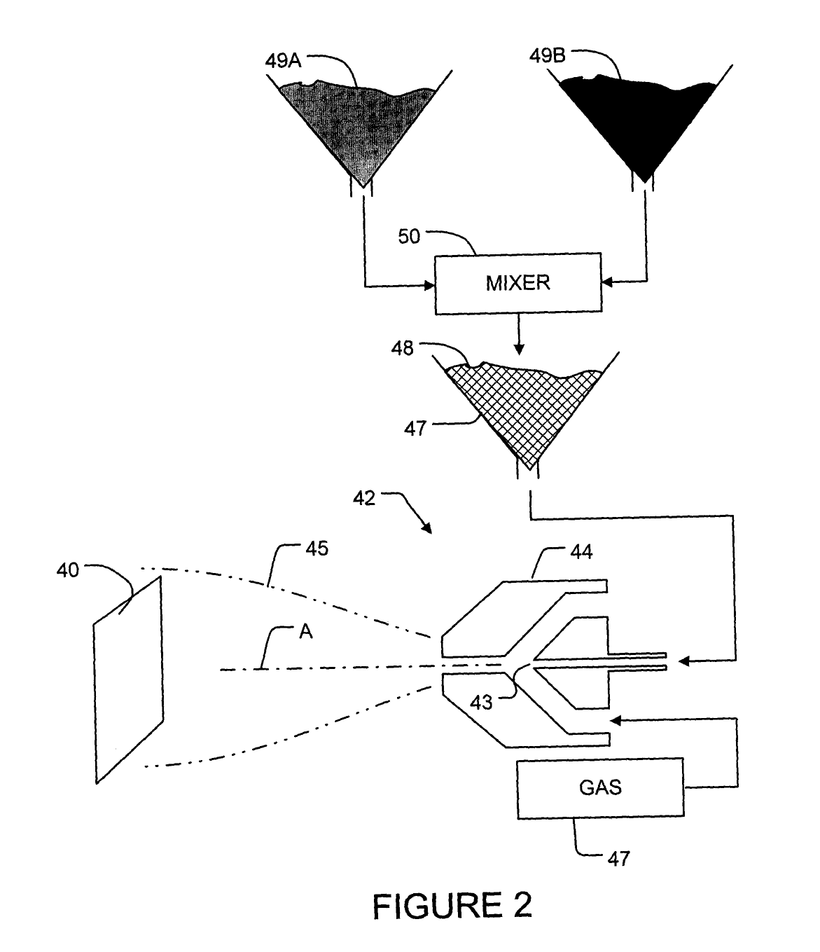

FIG. 1 shows a method 20 according to an embodiment of the invention. FIG. 2 illustrates schematically apparatus performing the method of FIG. 1. In block 22, method 20 provides a suitable substrate 40. Substrate 40 may comprise a suitable ceramic or metallic material, for example. In some embodiments, substrate 40 comprises a YSZ material.

In block 23 method 20 provides a mixture 48 of a copper-containing material and a ceramic.

In block 24 the mixture of a copper-containing material and a ceramic are applied to the substrate by thermal spraying. The thermal spraying could comprise high velocity oxy-fuel (HVOF) spraying or plasma spraying, for example. In a preferred embodiment, the thermal spraying comprises plasma spraying. The plasma spraying may be performed, for example, using an axial injection plasma spraying system 42. In the embodiment illustrated in FIG. 2, plasma spraying system 42 comprises a powder injection nozzle 43 that injects powders along an axis A of a plasma torch 44. The powders become entrained in a hot plasma 45 generated by plasma torch 44 and are carried to substrate 40. The plasma spraying system 42 may comprise, for example, an Axial III™ plasma spray system available from Northwest Mettech Corp. of North Vancouver, Canada. Plasma spray system 42 includes a suitable controller, electrodes, and current supply that are not shown in FIG. 2 for clarity.

FIG. 2 shows a hopper 47 containing a mixture 48 that is delivered to injection nozzle 43. Mixture 48 comprises a mixture of a powdered copper-containing material 49A and a powdered ceramic material 49B. In the illustrated embodiment, a mixer 50 mixes materials 49A and 49B to create mixture 48.

Copper-containing material 49A may comprise, for example:
copper,
a copper oxide,
an alloy of copper with one or more other metals,
a mixture of copper and one or more other metals,
a mixture of a copper oxide with oxides of one or more other metals,
an oxide of an alloy of copper with one or more other metals, or
mixtures thereof.

Powdered ceramic material 49B may comprise, for example:
ceria,
samaria doped ceria (SDC),
gadolinia doped ceria (GDC),
yttria-stabilized zirconia (YSZ),
lanthanum strontium gallium magnesium oxide (LSGM),
another suitable ceramic that is ionically-conducting, or both ionically and electronically conducting, or
a mixture thereof.

Mixture 48 may optionally comprise a material that functions as a pore former. Some examples of pore formers are:
carbon spheres;
organic materials that can be oxidized away (some examples are polymers such as polyethylene spheres, or starch, or flour—any low-temperature oxidizing material based primarily on C, H, and O can serve as a pore former if it is solid at room temperature and can be made into spheres or other particles that can be fed with mixture 48).

The particles of mixture 48 may optionally be fed into the plasma as a suspension in a suitable liquid. The liquid may be water, ethanol, mixtures of those, or other suitable liquids. The concentration of solids in the suspension may be 1-10 weight percent of solid in liquid in some embodiments. Other concentrations may also be used.

Where copper-containing material 49A comprises a copper oxide and it is desired that the structure being made comprises copper metal then the copper oxide may be reduced in situ after the plasma co-deposition has been performed. In FIG. 1, reduction of copper oxide is performed in block 26. The reduction may be performed by heating the deposited layer in a hydrogen atmosphere, for example. Reduction of copper oxide in situ tends to provide a microstructure having increased porosity as compared to the as-sprayed coating.

The methods described herein may be applied, for example, to make
Cu-ceria (e.g. Cu—CeO₂) electrodes or composites;
Co—Cu-ceria (e.g. Cu—Co—CeO₂) electrodes or composites;
Cu-SDC electrodes or composites;
Cu—Co-SDC electrodes or composites;
Cu-GDC electrodes or composites;
Cu—Co-GDC electrodes or composites; and,
Cu, Co, CuO, Co₃O₄, CoO, or cerium oxide (doped or undoped) coatings. The methods may also be applied to make electrodes, composites or coatings of other materials.

In some embodiments, an electrode structure is formed in a series of layers each having differing properties. In such embodiments, the composition of the electrode varies with depth. For example, in some embodiments, an SOFC anode has higher ceramic content near its interface with the electrolyte, and higher metal content near the surface for better current collection. In some embodiments, the metal content exceeds 40% or 50% near the surface of the anode. In some embodiments, the properties of the deposited material are caused to vary with position. Improved ability to control and vary the microstructure and material composition across the electrode may lead to better performance and reduced thermal stresses resulting from thermal expansion coefficient (CTE) mismatch, and thus increase cell efficiency and durability.

Electrode structures according to some embodiments of the invention are characterized by one or more of the following features:
copper and ceramic phases are well mixed on a fine scale (the relative amounts of the copper and ceramic phases may be constant or may vary with position in the electrode structure);
the copper provides good electrical conductivity;
the copper makes up about 40% of the solid volume of the electrode layer;
the electrode layer(s) are porous (in some embodiments having a porosity on the order of 40%);
the ceramic phase is catalytically active.

The substrate may be selected from a variety of suitable materials. For example, the substrate could comprise:
a YSZ substrate.
a porous metal support. Such a support could serve as an interconnect in a fuel cell. Electrolyte and cathode structures could be deposited on top of the anode layers.
an interconnect substrate with first a cathode and then an electrolyte deposited over it could serve as a substrate for deposition of an anode.
   The interconnects, electrolyte, and cathodes could comprise any suitable materials (e.g. YSZ, LSGM, SDC, GDC for electrolytes, LSM, LSF, LSC, LSCF, PSCF, BSCF for cathodes, steels—especially high-chromium steels—or Ni-based alloys for interconnects).

In an example embodiment a YSZ (Tosoh, 8 mol % Y₂O₃) substrate was made by ball-milling a mixture of 60 wt % YSZ powder, 12 wt % Ethyl Alcohol, 12 wt % Toluene, 5 wt % PVB, and 7 wt % Butyl benzyl phthalate for several hours. After ball-milling the mixture was tape cast. The tape was cut and sintered at 1400° C. to produce a dense electrolyte support.

### EXAMPLE #1

In an example embodiment, a copper-SDC SOFC anode was made by co-depositing copper oxide and SDC (Ce_{0.8}Sm_{0.2}O_{1.9}) on a one-inch circular YSZ substrate using an axial injection plasma torch. The resulting anode was subsequently reduced to Cu-SDC and then tested electrochemically in a double-anode symmetrical fuel cell.

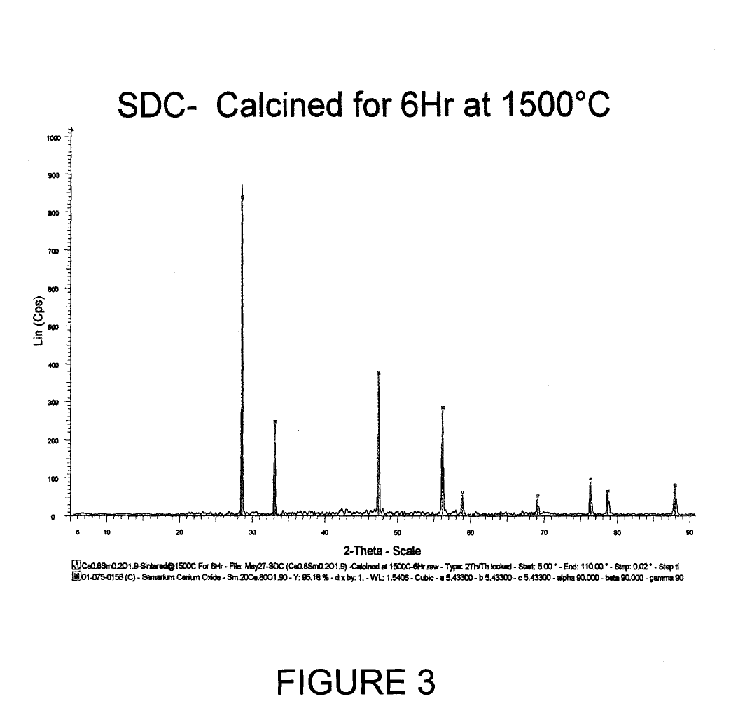

Samaria doped ceria (Ce_{0.8}Sm_{0.2}O_{1.9}) was synthesized by mixing cerium carbonate and samarium acetate (obtained from Inframat Advanced Materials, Connecticut, USA). The mixture was ball milled with 40 wt % ethanol for 48 hours. The ball milled mixture was then calcined at 1500° C. for 6 hrs. FIG. 3 shows an X-ray diffraction pattern for the calcined powder which confirms that the powders reacted to form single phase SDC (Ce_{0.8}Sm_{0.2}O_{1.9}).

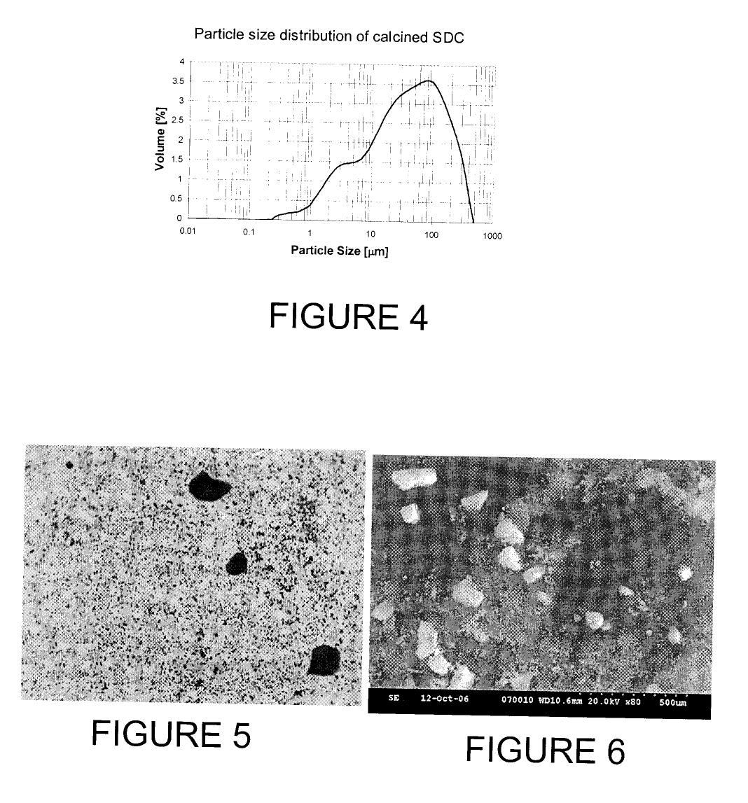

Particle size analysis was conducted using a wet dispersion optical particle size analyzer (Malvern Mastersizer 2000™). FIG. 4 shows the particle size distribution of the calcined synthesized SDC. The analysis showed a particle size range of 0.25 μm-550 μm, with d_{0.1}=3.33 μm, d_{0.5}=39.7 μm, d_{0.9}=205 μm.

FIGS. 5 and 6 are respectively optical and scanning electron micrographs of the calcined SDC particles (sieved to +75-108 μm). The magnification of FIG. 5 is 400×. These Figures show that the particles have an irregular non-spherical shape, with a large relative volume of smaller particles (<75 μm) that form larger agglomerates which appear to break easily into smaller particles. It can be seen that the particles are agglomerates of much smaller primary particles which easily break, resulting in a non-homogenous particle size distribution.

YSZ (yttria stabilized zirconia) substrates were prepared by pressing 4 g YSZ powder (available from Inframat Advanced Materials) into pellets with a 32 mm die. The pellets were sintered to substrates at 1400° C. for 4 hrs. The sintered YSZ substrates were sand blasted prior to spraying to create a coarse surface in order to allow better adhesion of the coating to the surface. After sand blasting, the surfaces were cleaned with acetone to remove any residue.

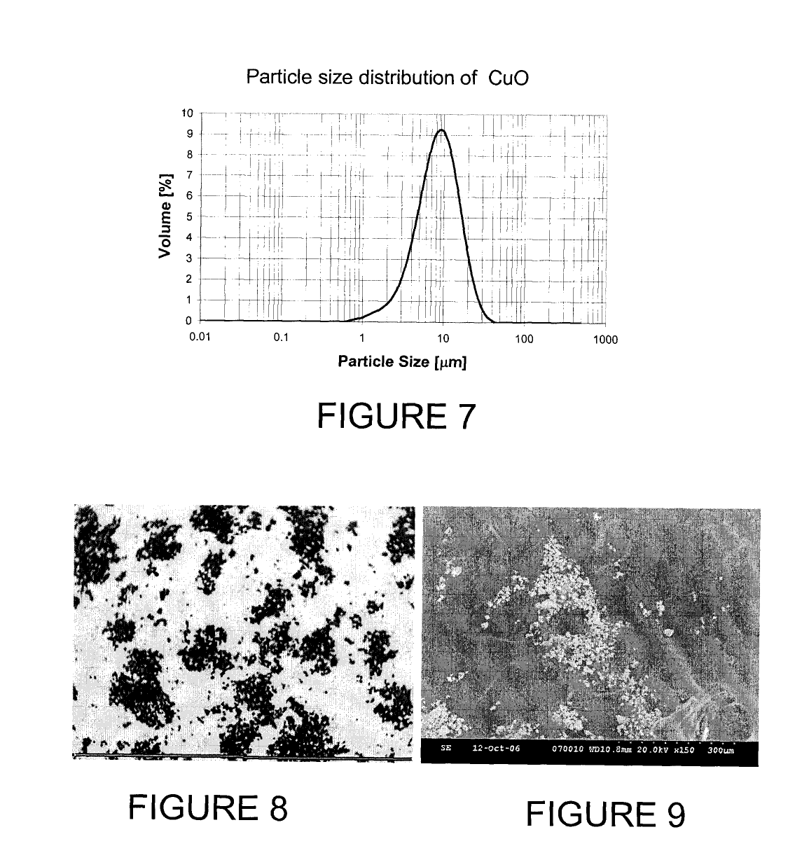

CuO and SDC powders were co-deposited to form a coating on the substrates. In one test, CuO powder (Inframat Advanced Materials, particle size d_{0.5}=9 μm) and SDC powder (synthesized from pre-cursors and sieved to a particle size range of +32-75 μm) were mixed in a weight ratio of 1:1. FIG. 7 shows the particle size distribution of the CuO powder as received. The CuO powder particle size ranges from 0.60 μm-40.0 μm, with d_{0.1}=3.82 μm, d_{0.5}=9.05 μm, d_{0.9}=18.5 μm. Image analysis of as-received CuO particles shows that the particles have an irregular non-spherical shape. FIG. 8 and FIG. 9 show optical microscope and SEM images, respectively, of the as-received CuO powder.

The dry mixed powders were plasma sprayed from a single hopper onto an electrolyte support utilizing a Mettech Axial III™ axial injection torch (available from Northwest Mettech Corp. of North Vancouver, Canada). The YSZ substrates were mounted onto a turntable to allow cooling of the substrate during the spraying by contact with the air during the turntable rotation. Table 1 shows the spraying and feedstock conditions for all coatings produced during this experiment.

Table 2 shows the spraying and feedstock parameters used for the plasma spraying. With the apparatus used in this experiment plasma gas flow rate, plasma gas composition, and gun current are independently controlled. Gun power is dependent on other settings. In each case the plasma gas was a mixture of 50% nitrogen and 50% argon.

TABLE 1
Spraying and feedstock conditions

| | |
|---|---|
| Powder feed-rate [g/min] | 16 |
| Carrier gas flow-rate [slm] | 15 |
| Spraying distance [mm] | 150 |
| SDC particle size [μm] | 75 + 32 |
| CuO particle size [μm] | 25 |
| Nozzle diameter [in] | ½ |
| Weight Ratio CuO/SDC | 1:1 |
| Substrate | YSZ |
| Transverse speed [m/sec] | 4.25 |

TABLE 2
Spraying parameters for a range of example Cu-SDC composite coatings.

| | Plasma gas flow | | |
|---|---|---|---|
| Sample | rate [slm] | Gun current [A] | Gun power [kW] |
| 1 | 160 | 240 | 56.5 |
| 2 | 180 | 240 | 59.4 |
| 3 | 180 | 200 | 51 |
| 4 | 160 | 200 | 47.2 |
| 5 | 140 | 200 | 42.0 |

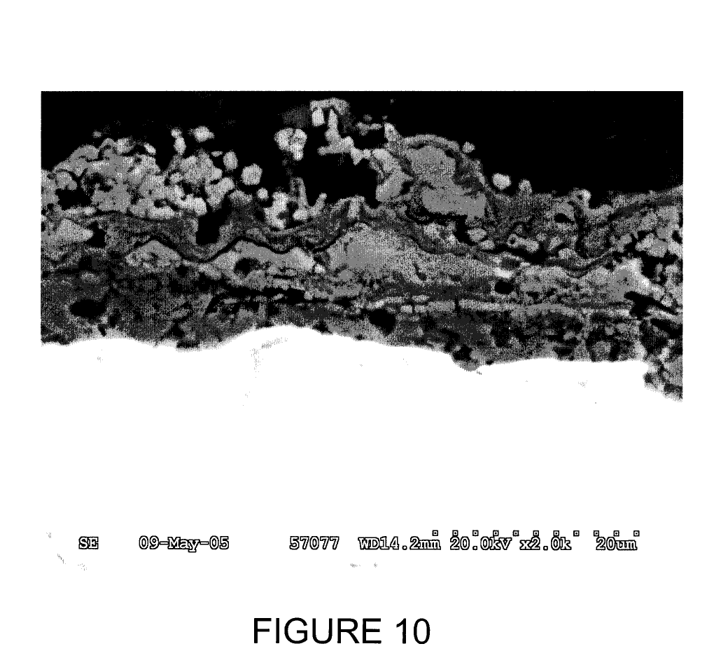

The sprayed samples were cut and polished. The coating was imaged with a scanning electron microscope to study the porosity and uniformity of the microstructure. FIG. 10 is an electron micrograph of sample 1 from Table 2. It can be seen that the coating forms distinct layers that are rich in CuO and SDC respectively. In a Cu-SDC SOFC anode, it is desirable that the copper and ceramic phases be well-mixed. Improved mixing of these phases can be obtained by selecting particle sizes and configurations that are delivered uniformly into the plasma as described, for example, in relation to Example #4 below.

### EXAMPLE #2

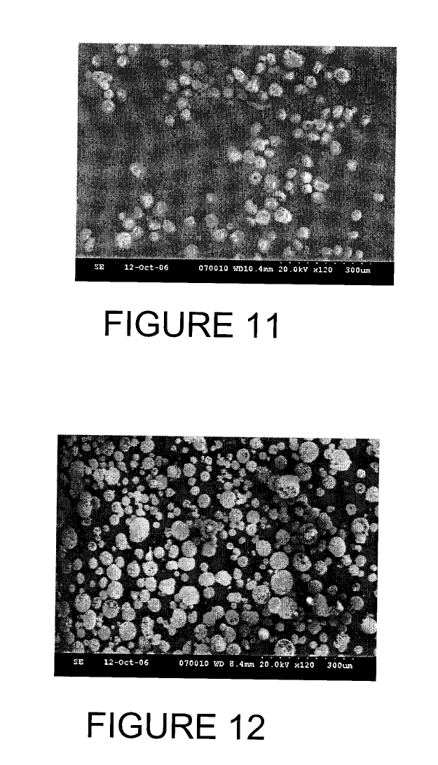

In another experimental example embodiment, spray-dried SDC and CuO powders (available from Inframat Advanced Materials) were co-deposited by plasma spraying. Particles in a spray-dried powder tend to have spherical shapes that tend to reduce stratification of powders being fed together in a plasma spray system. The powder particles used in this experiment are agglomerates of nano-powder. SDC powder (Ce_{0.8}Sm_{0.2}O_{1.9}) from Inframat Advanced Materials, particle size +45-75 μm, and CuO powder from Inframat Advanced Materials, particle size +45-75 μm were mechanically mixed in a weight ratio of 1.5 g SDC to 1 g of CuO. FIGS. 11 and 12 are scanning electron microscope images of the SDC and CuO spray-dried powders respectively.

The mixture was then plasma sprayed onto a YSZ substrate. Tables 3 and 4 show the plasma and feedstock conditions and spraying parameters that were utilized for the co-deposition of spray dried CuO and SDC.

TABLE 3
Spraying and feedstock conditions

| | |
|---|---|
| Powder feed-rate [g/min] | 16 |
| Carrier gas flow-rate [slm] | 15 |
| Spraying distance [mm] | 150 |
| SDC particle size [μm] | ~75 + 45 |
| CuO particle size [μm] | ~75 + 45 |
| Nozzle diameter [in] | ½ |
| Weight Ratio CuO/SDC | 0.667:1 |
| Substrate | YSZ |
| Transverse speed [m/sec] | 4.25 |

TABLE 4
Spraying parameters for a range of Cu-SDC composite coatings.

| | Plasma gas | Gun | Gun | Gas | Gas |
|---|---|---|---|---|---|
| | flow rate | current | power | Composition | Composition |
| Sample | [slm] | [A] | [kW] | % N₂ | % Ar |
| 6 | 200 | 220 | 54.6 | 40 | 60 |
| 7 | 240 | 220 | 85.6 | 75 | 25 |
| 8 | 200 | 240 | 89.3 | 75 | 25 |
| 9 | 250 | 230 | 82.9 | 60 | 40 |
| 10 | 220 | 230 | 93.9 | 90 | 10 |
| 11 | 220 | 230 | 84.0 | 60 | 40 |

Visual observation of the YSZ substrates revealed that the YSZ substrates tended to break during the spraying, presumably due to thermal shock. This problem was ameliorated by improving the cooling of the YSZ substrate during the spraying by improving the contact of the substrate holder with the cooling air. SEM imaging of the coating was performed to determine the porosity and uniformity of the microstructure. EDX imagining was performed to determine the relative amounts of CuO and SDC in the coating.

The relative amounts of Cu and SDC in the coatings of this Example #2 and of Example #3 below were calculated (Table 5). Both materials were present in all the coatings, but the relative amounts of each phase changed as a function of the spraying conditions. The relative deposition efficiency of CuO in the CuO-SDC coating was also calculated for the different spraying conditions. The initial volume of CuO in the CuO-SDC powder mixtures was 42.93%. The relative deposition efficiency was calculated as the ratio between the relative volume of CuO in the CuO-SDC coatings and the relative volume of CuO in the CuO-SDC powders. Table 5 also shows the calculated relative volume of Cu in the solid phase of Cu-SDC coatings after full reduction of the deposited CuO in the coatings to Cu.

TABLE 5

| | | | Deposition |
|---|---|---|---|
| | Volume Fraction | | efficiency of CuO |
| | Cu | Volume Fraction | relative to |
| | in coating after | CuO in coating | deposition |
| Sample | full reduction (%) | (%) | efficiency of SDC |
| 6 | 32.06 | 45.49 | 1.06 |
| 7 | 12.70 | 20.46 | 0.48 |
| 8 | 14.30 | 22.78 | 0.53 |
| 9 | 21.32 | 32.40 | 0.75 |
| 10 | 11.80 | 19.14 | 0.45 |
| 11 | 17.07 | 26.69 | 0.62 |
| 12 | 23.62 | 35.33 | 0.82 |
| 13 | 32.14 | 45.56 | 1.06 |
| 14 | 25.45 | 37.62 | 0.88 |
| 15 | 11.16 | 18.16 | 0.42 |

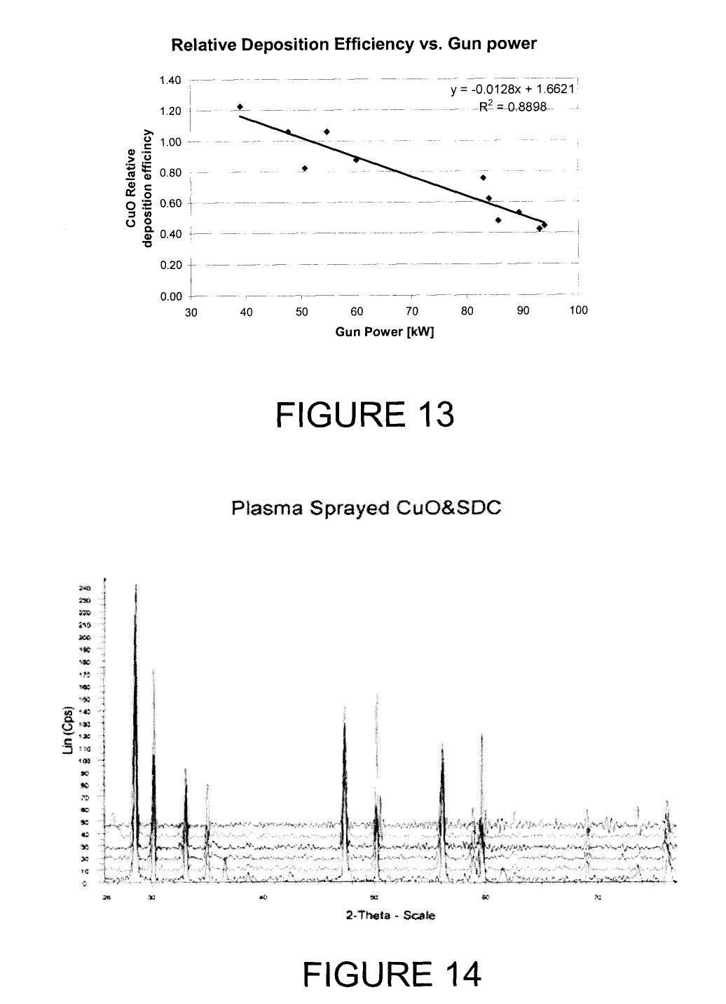

FIG. 13 shows the correlation between the relative deposition efficiency and gun power. It can be seen that the relative deposition efficiency of CuO compared to that of SDC generally decreases with higher gun power for the range of conditions studied. The relative deposition efficiency should be taken into account in determining the initial weight ratios of the CuO and SDC powders to be used in the production of coatings. It is generally desirable to provide a volume fraction of the Cu in the solid phases of the anode in excess of 30%, preferably 40% or more to assure full percolation of the Cu in the Cu-SDC anodes after reduction.

FIG. 14 shows X-ray diffraction patterns for the as-deposited coatings of samples 6 to 11. Both materials remained crystalline over the entire range of spraying conditions, and no evidence of amorphous phases or of partial reduction of CuO to Cu₂O was seen. The graphite detected in sample 10 was applied during SEM examination.

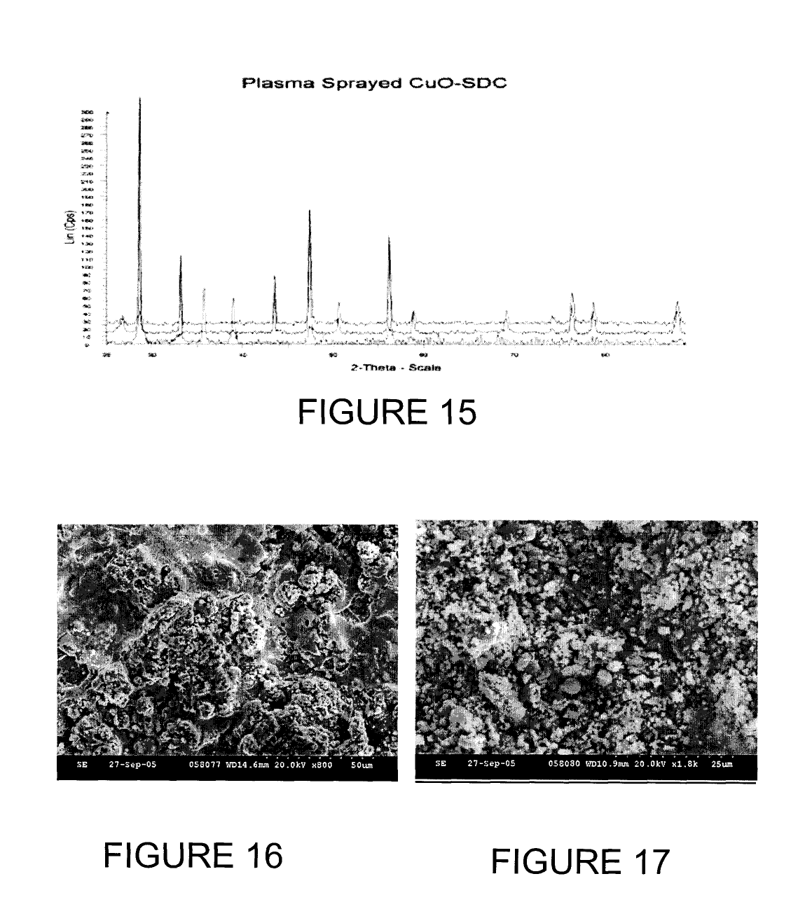

The as-deposited coatings were then treated to reduce the CuO to copper. FIG. 15 shows X-ray diffraction patterns for samples 12 and 13 together with an X-ray diffraction pattern for the mixed powders before spraying. These X-ray diffraction patterns show that the CuO was fully reduced to Cu. The graphite detected in the coating made using the conditions of run #12 in Table 5 was applied during SEM examination.

FIGS. 16 and 17 are scanning electron microscope micrographs of coatings produced in different plasma conditions. FIG. 15 shows a coating formed in a high power (93.0 kW) plasma. The CuO phase is well melted and forms splats that spread over the less melted SDC particles. FIG. 16 shows a coating formed in a low-power plasma (47.7 kW). It can be seen that the CuO is already well melted, even in the lower-power plasma. It can also be seen that the spray dried SDC agglomerates break up into smaller particles during the spraying process. This is likely a result of a combination of low particle temperature and high particle velocity during the impact with the substrate. Over the spraying conditions examined, the CuO tends to melt easily to form thin, fairly dense layers within the coating.

### EXAMPLE #3

CuO-SDC coatings were applied to substrates and then processed to reduce the CuO to copper. CuO and SDC powders were mechanically mixed with a weight ratio of 0.667. The powders were then sprayed on stainless steel coupons using the feedstock and spraying conditions in Table 3. Table 6 shows the spraying parameters utilized for the reduction studies of the coatings.

TABLE 6
Spraying parameters

| | Plasma | | | | |
|---|---|---|---|---|---|
| | gas | | Gun | Gas | Gas |
| | flow rate | Gun | power | Composition | Composition |
| Sample | [slm] | current [A] | [kW] | % N₂ | % Ar |
| 12 | 200 | 200 | 50.7 | 40 | 60 |
| 13 | 200 | 180 | 47.7 | 40 | 60 |
| 14 | 200 | 250 | 60.0 | 40 | 60 |
| 15 | 200 | 230 | 93.0 | 60 | 40 |

The coatings were reduced after deposition in dry hydrogen at 700° C. for 5 hours. X-ray diffraction and energy-dispersive X-ray analysis were conducted to determine the phases and elemental composition of the materials in the coating after the reduction.

### EXAMPLE #4

Another test co-deposited CuO and SDC with spraying distances smaller than 150 mm. Particle sizes of both CuO and SDC were adjusted to improve the coating microstructures. The particle size of the SDC powder was decreased to allow better melting in lower plasma energy conditions, and thus to allow its deposition onto a YSZ substrate without breaking the substrate due to thermal shock. It was found that the CuO particles melt completely and form large continuous splats in even the lowest energy plasmas used for spraying. In some tests, smaller CuO particles (having diameters of approximately 25 μm) were used. The smaller particles allow more fine scale mixing of the CuO splats with the SDC in the coating, resulting in a better microstructure for use as an anode. In addition, the plasma gas flow rate was decreased to allow a higher residence time of the particles in the plasma. Higher residence time increases the particle temperature, and allows better melting in lower energy plasmas.

The conditions utilized in this test were found to produce porous well-mixed coatings. These conditions were used to deposit symmetrical concentric anodes on both sides of YSZ electrolyte substrates using a custom made mask. Tables 7 and 8 show, respectively, the spraying and feedstock conditions and the spraying parameters that were utilized for these tests.

TABLE 7
Spraying and feedstock conditions

| | |
|---|---|
| Powder feed-rate [g/min] | 18 |
| Carrier gas flow-rate [slm] | 15 |
| Spraying distance [mm] | 100 |
| SDC particle size [μm] | −32 + 25 |
| CuO particle size [μm] | −25 |
| Nozzle diameter [in] | ½ |
| Weight Ratio CuO/SDC | 0.667:1 |
| Substrate | YSZ |
| Transverse speed [m/sec] | 4.25 |

TABLE 8
Spraying parameters

| | | Gun | Gun | Gas | Gas |
|---|---|---|---|---|---|
| | Plasma gas | current | power | Composition | Composition |
| Sample | flow rate [slm] | [A] | [kW] | % N₂ | % Ar |
| 16 | 180 | 180 | 47.4 | 40 | 60 |

The coating was reduced in H₂ at 700° C. for 5 hours. SEM imaging of the coating was performed to determine the porosity and uniformity of the microstructure. Symmetrical cell testing was performed using an SOFC test station (AMEL, Italy) and an FRA and potentiostat (Solartron™ 1260 and 1470E, UK) after in-situ reduction of the anodes at 569° C. in hydrogen. Additional symmetrical cells and anode coatings were reduced in H₂ at 700° C. for 5 hrs. EDX measurements were conducted on the reduced cells to confirm that a sufficient volume fraction of Cu was present in the coatings for full percolation of the Cu phase. The test station design includes a thermocouple that measures the temperature close to the cell. Table 9 shows the furnace temperature profile and atmospheres used in testing the symmetrical cells.

TABLE 9
Furnace temperature profile and atmospheres

| | | | | | Gas |
|---|---|---|---|---|---|
| | Temp. | | | | flow rate |
| Stage | ° C. | Time | | Atmosphere | [cc/min] |
| Ramp | 600 | 3° | C./min | N₂-Dry H₂ mixture | 100 |
| | | | | (10% H₂) | |
| Dwell | 600 | 2 | hrs | Dry H₂ | 100 |
| Ramp | 650 | 3° | C./min | Dry H₂ | 100 |
| Dwell | 650 | 1.5 | hrs | Dry H₂ | 100 |
| Ramp | 700 | 3° | C./min | Dry H₂ | 100 |
| Dwell | 700 | 1.5 | hrs | Dry H₂ | 100 |
| Ramp | 750 | 3° | C./min | Dry H₂ | 100 |
| Dwell | 750 | 1.5 | hrs | Dry H₂ | 100 |
| Ramp | 800 | 3° | C./min | Dry H₂ | 100 |
| Dwell | 800 | 1 | hrs | Dry H₂ | 100 |
| Cooling | 30 | 3° | C./min | N₂-Dry H₂ mixture | 100 |
| down | | | | (10% H₂) | |

In Sample 16, the CuO particle size was decreased to reduce the size of the splats of the highly melted CuO particles and improve the extent of mixing with the SDC to improve the microstructure. SDC particle size was decreased to allow the coatings to be sprayed with a lower plasma power and to produce coatings on YSZ substrates without breaking them due to thermal shock. The plasma gas velocity was reduced to allow higher residence times of the particles in the flame and therefore better melting of the SDC particles. The decrease also reduces the particle velocity upon impacting the substrate, and thus can help to reduce the breaking of the SDC agglomerates upon impact, and thereby improve the microstructure by maintaining a more uniform particle size of the CuO and SDC in the final coating. The spraying distance was reduced to allow a more homogenous coating. Decreased spraying distance reduces the chances of re-solidification of the particles during flight before impacting the substrate.

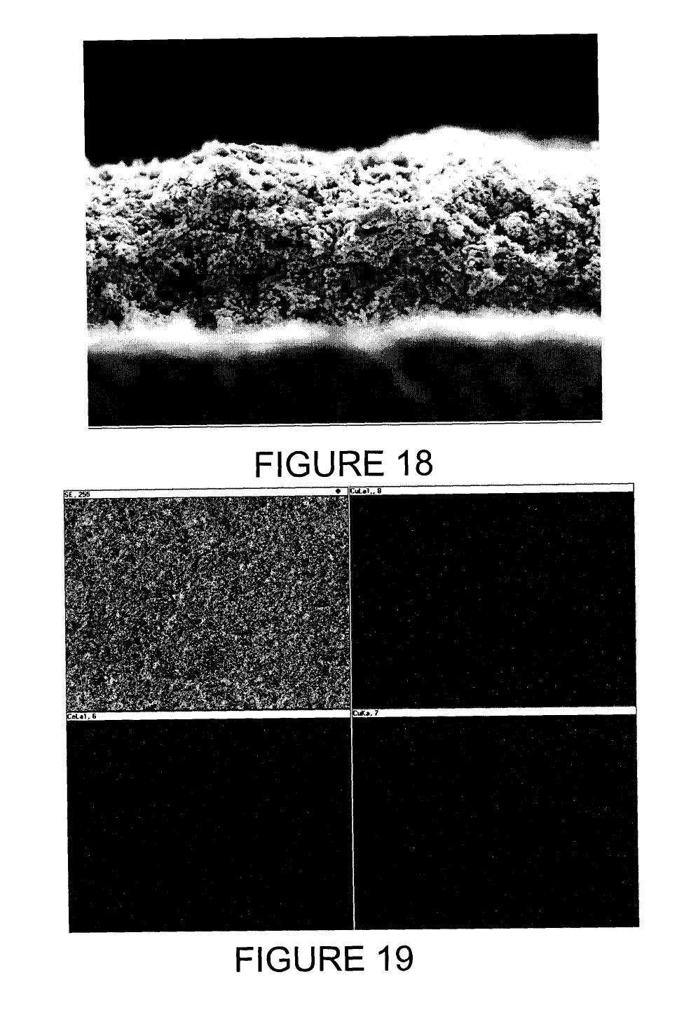

FIG. 18 shows a cross section SEM micrograph of the coating of sample 16 after reduction. It can be seen that decreasing the SDC and CuO particle sizes, spraying with a shorter standoff distance, and applying a low plasma gas flow rate resulted in coatings with a uniform, porous, and well mixed microstructure with the desired characteristics of anodes: high surface area, porosity, and CuO-SDC contact. FIG. 19 shows an EDX map of the coating. The CuO and SDC phases are well mixed. The EDX measurements show that the volume fraction of Cu in the coating after reduction was 39.75 vol %.

Impedance spectroscopy was conducted at cell temperatures of 569° C., 620° C., 672° C., 723° C., and 772° C., using the testing conditions shown in Table 10. The measurements were repeated several times at each temperature.

TABLE 10
Testing conditions used for impedance spectroscopy
measurements

| Testing condition | Value |
|---|---|
| Voltage with respect to open circuit | 0 V |
| Voltage perturbation amplitude | 50 mV |
| Frequency range | 2 mHz-1 MHz |

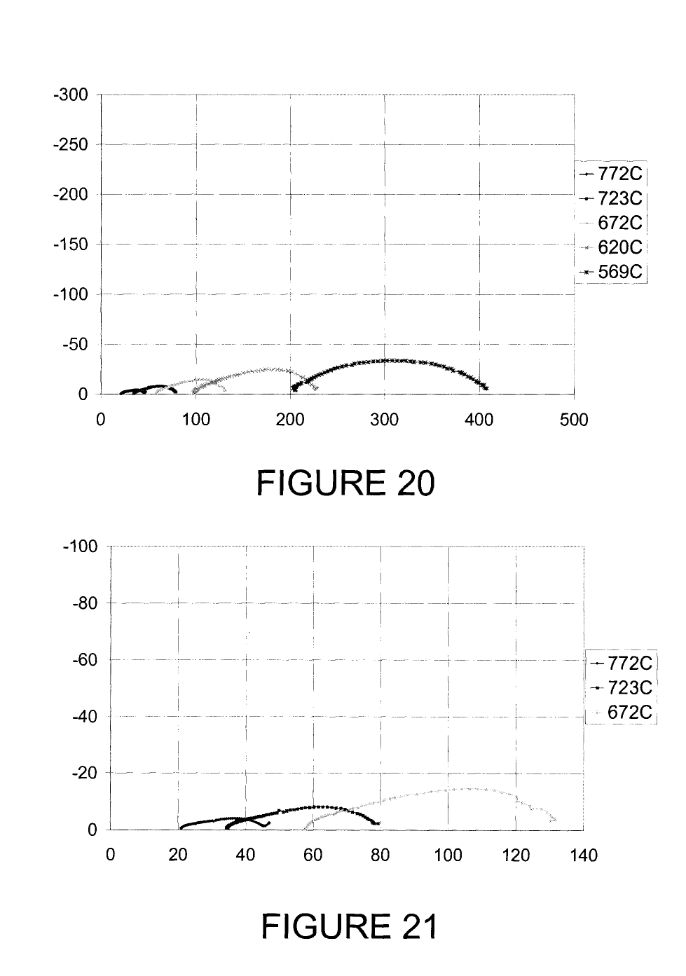

FIGS. 20 and 21 show the impedance spectra of the symmetrical cell for the entire temperature range, and for the temperature range from 672° C.-772° C., respectively. Each impedance spectrum shown was obtained after 30 minutes of dwelling at the test temperature. The double-anode symmetrical cell impedance tests in hydrogen found area-specific polarization resistances of 12.3 ohm cm² around the open circuit voltage at 772° C.

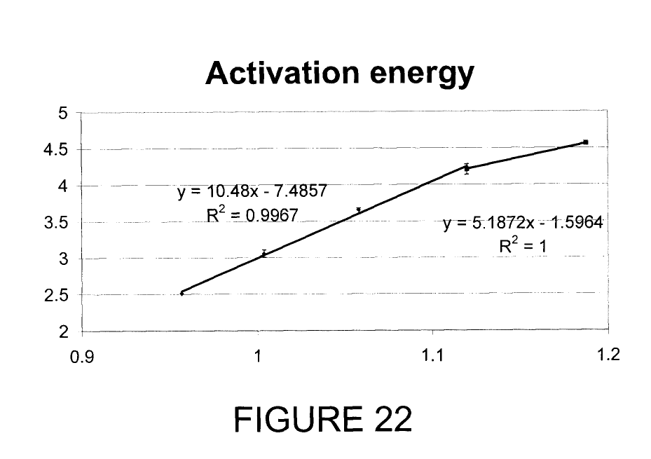

FIG. 22 shows an Arrhenius plot of the natural logarithm of the area-specific polarization resistance ln(ASRₚ) vs 1000/T. A change in slope can be identified in the plot at approximately 620° C., possibly indicating that different reaction mechanisms determine the rate of reaction above and below that temperature.

Producing Cu-SDC anodes by plasma spraying allows a much faster method of producing direct oxidation SOFC anodes than is currently possible using wet ceramic techniques involving infiltration of a porous sintered pre-form. The technique developed allows CuO and SDC to be co-deposited by plasma spraying, despite the very large high melting temperature difference between the two materials. Control of the anode microstructure is possible during the deposition process by adjusting the spraying conditions and particle size distributions of the starting powders. CuO-SDC coatings with well mixed, porous microstructures demonstrate acceptable performance as anodes, even at fairly low temperatures and despite the low catalytic activity of copper. Further optimization of the microstructure of the coatings, together with the incorporation of additional materials with a higher catalytic activity, such as cobalt, can further improve the performance of the composite anode coatings for use in solid oxide fuel cells that can operate on multiple fuels.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

1. A method for making an electrode, the method comprising:
thermal spraying onto a substrate a mixture comprising a copper-containing material and a second material having a melting temperature greater than a melting temperature of the copper-containing material to provide a coating on the substrate.

2. A method according to claim 1 wherein the coating comprises a mixture of a first copper-containing phase and a second phase of the second material.

3. A method according to claim 2 wherein the first and second phases are both crystalline phases.

4. A method according to claim 1 wherein the mixture comprises a first powder and a second powder; and,
the first powder comprises the copper-containing material and the second powder is a powder comprising the second material.

5. A method according to claim 4 wherein the first powder comprises a cobalt-containing material.

6. A method according to claim 5 wherein the first powder comprises an alloy of copper and cobalt.

7. A method according to claim 5 wherein the first powder comprises an oxide of an alloy of copper and cobalt.

8. A method according to claim 5 wherein the first powder comprises one or more of copper and CuO and one or more of cobalt, CoO, and Co₃O₄.

9. A method according to claim 4 wherein the second powder comprises an oxidation catalyst.

10. A method according to claim 4 wherein the second powder comprises a ceramic.

11. A method according to claim 9 wherein the second powder comprises cerium oxide.

12. A method according to claim 11 wherein the second powder comprises a samarium dopant.

13. A method according to claim 12 wherein the second powder comprises Ce_{0.8}Sm_{0.2}O_{1.9}.

14. A method according to claim 11 wherein the second powder comprises a gadolinium dopant.

15. A method according to claim 4 wherein at least one of the first and second powders comprises particles having a rounded configuration.

16. A method according to claim 15 wherein the at least one of the first and second powders comprises a spray-dried powder.

17. A method according to claim 15 wherein the particles of the at least one of the first and second powders are substantially spherical.

18. A method according to claim 4 wherein an average size of particles in the first powder containing the copper-containing material is 30 μm or less.

19. A method according to claim 18 wherein an average particle size of the first powder is smaller than an average particle size of the second powder.

20. A method according to claim 19 wherein the first and second powders are made up of particles having diameters smaller than 100 μm.

21. A method according to claim 19 wherein the first and second powders are made up of particles having diameters smaller than 45 μm.

22. A method according to claim 19 wherein the second powder is made up of particles having diameters in the range of 20 to 40 μm.

23. A method according to claim 22 wherein the first powder is made up of particles having diameters of 35 μm or less.

24. A method according to claim 4 wherein providing the mixture comprises admixing a pore former with the first and second powders.

25. A method according to claim 1 wherein the copper-containing material comprises a copper oxide.

26. A method according to claim 25 wherein the copper oxide comprises cupric oxide.

27. A method according to claim 25 comprising, after thermal spraying the mixture, reducing the copper oxide to provide a metallic copper phase in the coating.

28. A method according to claim 27 wherein the coating comprises at least 40 vol % copper.

29. A method according to claim 10 wherein the thermal spraying comprises plasma spraying.

30. A method according to claim 29 wherein the plasma spraying comprises introducing the mixture into a plasma stream substantially on an axis of the plasma stream.

31. A method according to claim 30 wherein the plasma spraying is performed using a mixture of nitrogen and argon gases.

32. A method according to claim 31 wherein a ratio of nitrogen to argon is 40:60±10%.

33. A method according to claim 32 wherein the plasma spraying is performed using a plasma gun having a nozzle and a ratio of a plasma gas flow rate to a cross-sectional area of the nozzle is 140 l/min×cm²±10%.

34. A method according to claim 30 wherein the plasma spraying is performed with a plasma gun located so that a distance between the substrate and the plasma gun is less than 150 mm.

35. A method according to claim 34 wherein the plasma spraying is performed in air.

36. A method according to claim 29 wherein the plasma spraying comprises sequentially plasma spraying a plurality of layers, the layers having differing compositions.

37. A method according to claim 1 wherein the mixture comprises a cobalt containing material.

38. A method according to claim 1 wherein the melting temperatures of the copper-containing material and the second material differ by at least 1000° C.

39. A method according to claim 1 wherein the melting temperatures of the copper-containing material and the second material differ by at least 1500° C.

40. A method for forming a porous copper-containing coating on a substrate, the method comprising:
providing a mixture of a first powder comprising the copper in an oxidized state with a second powder comprising a ceramic material;
plasma spraying the mixture onto a substrate; and,
subsequently reducing the copper to metallic copper in situ.

41. A method according to claim 40 wherein providing the mixture comprises admixing a pore former with the first and second powders.

42. The use of a method according to claim 1 in the fabrication of an anode for a fuel cell.

43. An anode for a fuel cell comprising a plurality of layers, the layers each comprising a mixture of a crystalline copper metal phase and a crystalline ceramic phase, the layers having differing compositions.

44-45. (canceled)
